(19) United States
(12) Patent Application Publication
(10) Pub. No.: US 2016/0302115 A1
(43) Pub. Date: Oct. 13, 2016

(54) Backhaul of Client Network Nodes

(71) Applicant: TELEFONAKTIEBOLAGET LM ERICSSON (PUBL), Stockholm (SE)

(72) Inventors: Stefan Parkvall, Bromma (SE); Robert Baldemair, Solna (SE)

(73) Assignee: Telefonaktiebolaget LM Ericsson (publ)

(21) Appl. No.: 15/038,618

(22) PCT Filed: Dec. 4, 2013
(86) PCT No.: PCT/EP2013/075497

§ 371 Date: May 23, 2016

(51) Int. Cl. H04W 36/00; H04W 48/18; H04W 56/00; H04W 24/04; H04W 36/12

(52) U.S. Cl. CPC H04W 36/0083; H04W 24/04; H04W 36/12; H04W 56/001; H04W 48/18

(57) ABSTRACT

There is provided mechanisms for handling client network nodes backhauled by a hub network node. The hub network node acquires a need for backhaul re-configuration of a client network node being backhauled by the hub network node. The hub network node provides an indication to the client network node that a user equipment served by the client network node is to be handed over. The hub network node receives a report that the client network node has handed over the user equipment. The hub network node transmits at least one of synchronization and reference signals enabling client network nodes to search for the hub network node.

### TECHNICAL FIELD

Embodiments presented herein relate to handling client network nodes, and particularly to a method, a hub network node, a computer program, and a computer program product for handling client network nodes backhauled by a hub network node.

### BACKGROUND

In communications networks, it may be challenging to obtain good performance and capacity for a given communications protocol, its parameters and the physical environment in which the communications network is deployed.

For example, increase in traffic within communications networks such as mobile broadband systems and an equally continuous increase in terms of the data rates requested by end-users accessing services provided by the communications networks may impact how cellular communications networks are deployed. One way of addressing this increase is to deploy lower-power network nodes, such as micro network nodes or pico network nodes, within the coverage area of a macro cell served by a macro network node. Examples where such additional network nodes may be deployed are scenarios where end-users are highly clustered. Examples where end-users may be highly clustered include, but are not limited to, around a square, in a shopping mall, or along a road in a rural area. Such a deployment of additional network nodes is referred to as a heterogeneous or multi-layered network deployment, where the underlaid layer of low-power micro or pico network nodes does not need to provide full-area coverage. Rather, low-power network nodes may be deployed to increase capacity and achievable data rates where needed. Outside of the micro- or pico-layer coverage, end-users would access the communications network by means of the overlaid macro cell.

One challenge with a large deployment of small micro or pico cells is providing backhaul connections from a micro or pico network node (hereinafter a “client network node”) to a macro network node (hereinafter a “hub network node”) to establish a connection to the core network. Multiple solutions can be envisioned, including optical fibers and wireless backhaul solutions.

Traditionally, wireless backhaul operate at relatively high frequencies, in the order of 6-80 GHz or so, as spectrum in the lower frequency bands is scarce and preferably used for the access link between the user equipment of the end-users and network nodes serving as radio base stations for the user equipment. Operating at higher frequencies implies different propagation conditions than what is seen at the lower frequency bands where cellular access such as LTE (long term evolution telecommunications standard) typically operates. Due to propagation conditions at high frequencies, highly directive (i.e., narrow-beam) antennas are typically used. Often, wireless backhaul relies on line-of-sight propagation conditions, requiring an un-obstructed path between the two points of the backhaul connection. However, in many cases the client network nodes are placed where there is no line-of-sight propagation to the hub network nodes.

One way is to provide non-line-of-sight (NLOS) backhaul using already standardized technology, such as LTE. As mentioned above, highly directive antennas are required at one or both of the client network node and the hub network node to obtain good received signal strength and a corresponding high data rate. Prior to communicating between the client network node and the hub network node, the direction of the antennas therefore needs to be adjusted. One example of such adjustment includes a manual, mechanical, adjustment of the antennas as performed by a technician. Furthermore, the antenna directions may occasionally need to be adjusted due to changes in the environment.

Abeam can be formed in many ways, e.g., using one (directional) antenna and mechanically controlling the direction of the antenna, and/or using a antenna array with multiple antenna elements. By setting the appropriate weights on each antenna element, either in baseband or at radio frequency (RF) level, a beam can be formed. It is envisioned that the hub network node is configured for handling one or more beams. Typically, the direction of each beam is fixed. Different possibilities with respect to the RF circuitry for the beams exist. Some of these will be summarized next.

According to a first example, the same (or larger) number of RF chains (power amplifiers, filters, etc.) than the number of beams is used. This implies that transmission activity in one beam is independent from the activity in other beams.

According to a second example, a smaller number of RF chains than the number of beams is used. As an example, eight different beam directions may be supported but at most four of these may be used at the same time. One benefit with such a setup is the reduced number of RF components. However, this setup also implies a dependency between the transmission activity in different beams; simultaneous transmission may only occur in a subset of beams where the maximum number of simultaneously active beams is given by the number of RF chains.

At the client network node side, a narrow beam can be formed either electronically or mechanically. In either case, both manual and automatic adjustment of the direction may be possible.

One example of a procedure to perform beam searching between the hub network node and the client network node includes the hub network node to, during a cycle, sweep a beam through different sectors and transmits synchronization signals, such as primary and secondary synchronization signals (PSS/SSS) into each sector. This cycle may be repeated several times. During each cycle the client network node may maintain its receive beam pattern (beam forming). For the next cycle the client network node may switch to another beam pattern. FIG. 4 shows a graphic illustration of this procedure.

If a hub network node uses already all of its radio chains to serve client network nodes it cannot assist so far undetected client network nodes in their cell/hub search in sectors currently not used. This would imply to use one of the already occupied radios to transmit synchronization signals, such as PSS/SSS, into different sectors. If the hub network node would do that the client network node(s) currently served by the network node with this radio chain would lose its/their backhaul connection.

Hence, there is still a need for an improved handling of backhauled client network nodes.

### SUMMARY

An object of embodiments herein is to provide improved handling of backhauled client network nodes.

According to a first aspect there is presented a method for handling client network nodes backhauled by a hub network node. The method is performed by the hub network node. The method comprises acquiring a need for backhaul re-configuration of a client network node being backhauled by the hub network node. The method comprises providing an indication to the client network node that a user equipment served by the client network node is to be handed over. The method comprises receiving a report that the client network node has handed over the user equipment. The method comprises transmitting at least one of synchronization and reference signals enabling client network nodes to search for the hub network node.

Advantageously this enables improved handling of backhauled client network nodes.

Advantageously this enables the hub network node to enable cell/hub search of new client network nodes, and to connect new client network nodes to the hub network node without interrupting communications to UEs, despite the hub network node already using all its radio chains, thus having no unused radio chains left which could be dedicated for cell/hub search purposes.

According to a second aspect there is presented a hub network node for handling client network nodes backhauled by the hub network node. The hub network node comprises a processing unit, a storage medium, and a communications interface. The hub network node is arranged to acquire a need for backhaul re-configuration of a client network node being backhauled by the hub network node. The hub network node is arranged to provide an indication to the client network node that a user equipment served by the client network node is to be handed over. The hub network node is arranged to receive a report that the client network node has handed over the user equipment. The hub network node is arranged to transmit at least one of synchronization and reference signals enabling client network nodes to search for the hub network node.

According to a third aspect there is presented a computer program for handling client network nodes backhauled by a hub network node, the computer program comprising computer program code which, when run on the hub network node, causes the hub network node to perform a method according to the first aspect.

According to a fourth aspect there is presented a computer program product comprising a computer program according to the third aspect and a computer readable means on which the computer program is stored.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to embodiments;

FIG. 2a is a schematic diagram showing functional modules of a hub network node according to an embodiment;

FIG. 2b is a schematic diagram showing functional units of a hub network node according to an embodiment;

FIG. 2c is a schematic diagram showing hardware units of a hub network node according to an embodiment;

FIG. 3 shows one example of a computer program product comprising computer readable means according to an embodiment;

FIG. 4 schematically illustrates a beam search procedure according to an embodiment; and

FIGS. 5, 6 and 7 are flowcharts of methods according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

Hereinafter a network node to be backhauled is denoted a “client network node” (CNN) and a network node providing backhauls is denoted a “hub network node” (HNN). The client network node thus establishes a backhaul connection to the core network via the hub network node. In case of a wireless backhaul, the term client network node thus denotes the unit (or subunit within a micro or pico network node) that connects the micro or pico network node to the hub network node. The hub network node denotes the other end (with respect to the client network node) of the wireless backhaul link where the wireless backhaul continues over a wired connection to the core network. The hub network node may be co-located with a macro network node. Thus, the backhauled data may or may not be transported through a macro node.

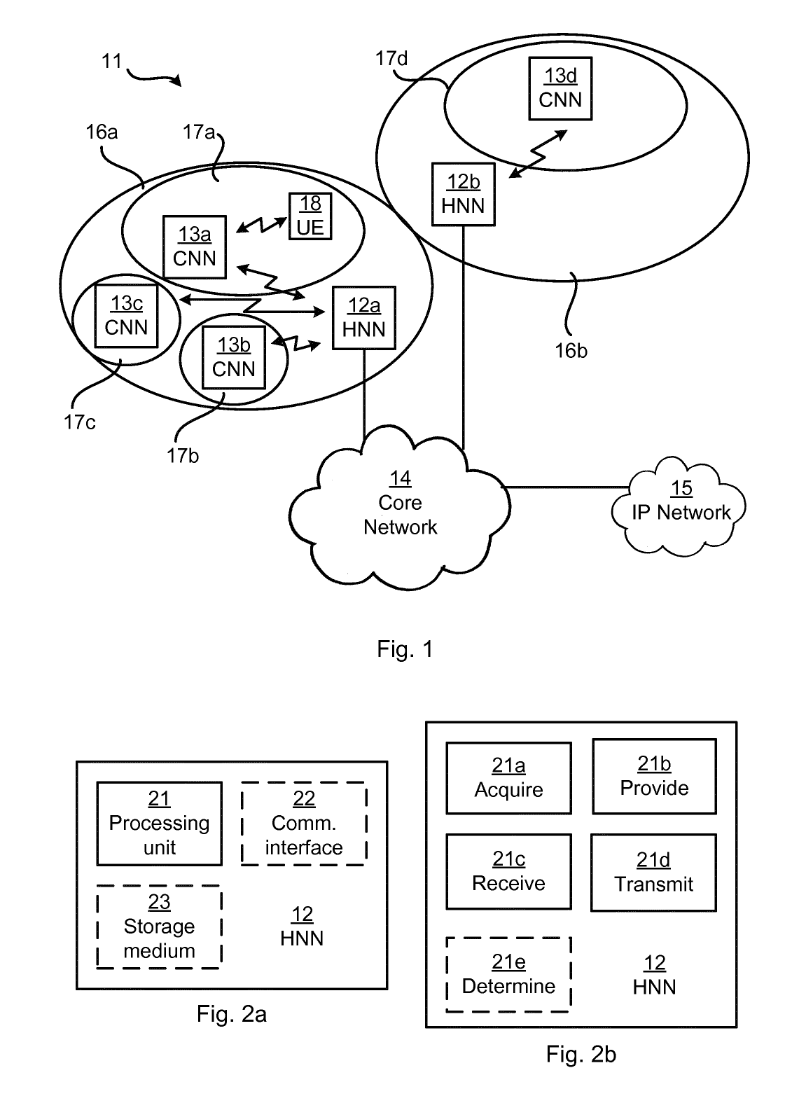

FIG. 1 is a schematic diagram illustrating a communications network 11 where embodiments presented herein can be applied. The communications network 11 comprises cells 17a, 17b, 17c, 17d served by client network nodes (CNNs) 13a, 13b, 13c, 13d. The client network nodes 13a-d are wirelessly backhauled by hub network nodes (HNNs) 12a, 12b. The hub network nodes 12a, 12b are operatively connected to a core network 14 which in turn is operatively connected to a service providing Internet Protocol based network 15. A user equipment (UE) 18 located in the cell 17a and served by the CNN 13a is thereby able to access services and data provided by the IP network 15.

Situations in which backhaul re-configuration of at least one client network node being backhauled by a hub network node is desired may occur. Embodiments disclosed herein relate to handle such situations. As herein disclosed it is proposed to move UEs that are currently served by a client network node that is backhauled by the hub network node to another cell. This other cell may be the overlaid macro cell served by the hub network node or another macro cell or another pico cell. The UEs are moved since the backhaul will be interrupted. This is because the hub network node will use the radio chain serving the client network node to transmit signals into other sectors to support cell/hub search of new client network nodes. Alternatively the client network nodes can be switched to be served by another backhaul beam, either from the same hub network node or another hub network node.

The embodiments disclosed herein thus relate to handling of client network nodes 13a-d backhauled by a hub network node 12a, b. In order to obtain handling of client network nodes 13a-d backhauled by a hub network node 12a, b there is provided a hub network node 12a, b, a method performed by the hub network node 12a, b, a computer program comprising code, for example in the form of a computer program product, that when run on the hub network node 12a, b, causes the hub network node 12a, b to perform the method.

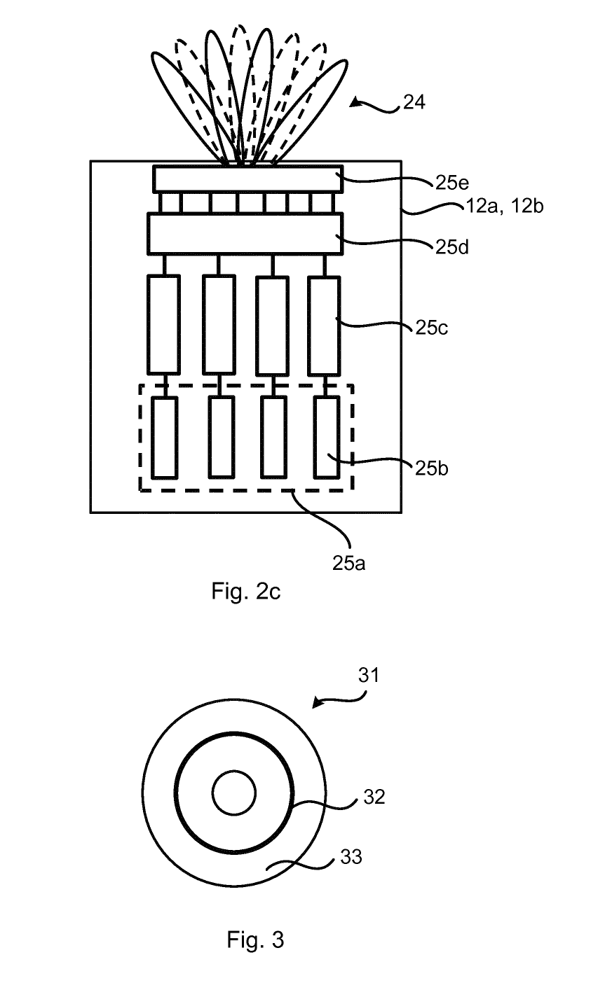

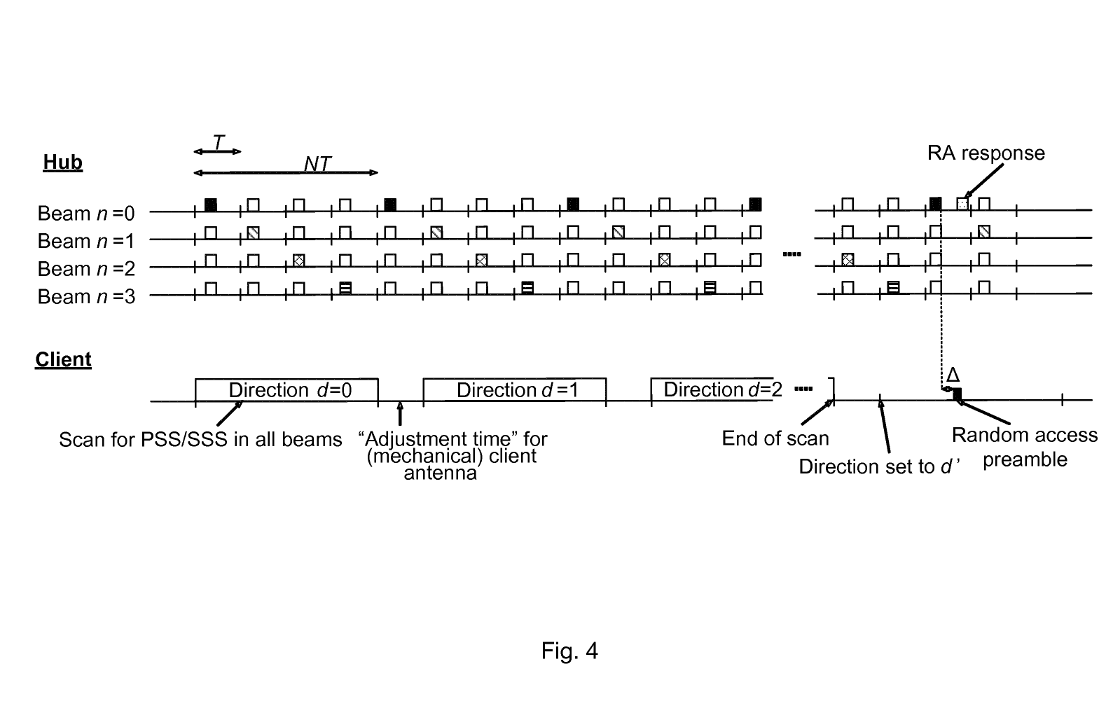

FIG. 2a schematically illustrates, in terms of a number of functional modules, the components of a hub network node 12a, b according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 31 (as in FIG. 3), e.g. in the form of a storage medium 23. Thus the processing unit 21 is thereby arranged to execute methods as herein disclosed. The storage medium 23 may also comprise persistent storage, which, for example, can be any single one or combination of magnetic memory, optical memory, solid state memory or even remotely mounted memory. The hub network node 12a, b further comprises a communications interface 22 for communications with at least one client network node 13a-d, and for communications with the core network 14. As such the communications interface 22 may comprise one or more ports, transmitters and receivers, comprising analogue and digital components and a suitable number of antennae for radio communications with at least one client network node 13a-d and for communications with the core network 14. The processing unit 21 controls the general operation of the hub network node 12a, b e.g. by sending data and control signals to the communications interface 22 and the storage medium 23, by receiving data and reports from the communications interface 22, and by retrieving data and instructions from the storage medium 23. Other components, as well as the related functionality, of the hub network node 12a, b are omitted in order not to obscure the concepts presented herein.

FIG. 2b schematically illustrates, in terms of a number of functional units, the components of a hub network node 12a, b according to an embodiment. The hub network node 12a, b of FIG. 2b comprises a number of functional units; an acquire unit 21a, a provide unit 21b, a receive unit 21c, and a transmit unit 21d. The hub network node 12a, b of FIG. 2b may further comprises a number of optional functional units, such as a determine unit 21e. The functionality of each functional unit 21a-e will be further disclosed below in the context of which the functional units may be used. For example, herein disclosed steps of acquiring may be performed by executing the functionality of the acquire unit 21a, herein disclosed steps of providing may be performed by executing the functionality of the provide unit 21b, herein disclosed steps of receiving may be performed by executing the functionality of the receive unit 21c, herein disclosed steps of transmitting may be performed by executing the functionality of the transmit unit 21d, and herein disclosed steps of determining may be performed by executing the functionality of the determine unit 21e. In general terms, each functional unit 21a-e may be implemented in hardware or in software. The processing unit 21 may thus be arranged to from the storage medium 23 fetch instructions as provided by a functional unit 21a-e and to execute these instructions, thereby performing any steps as will be disclosed hereinafter.

FIG. 2c schematically illustrates some units of a hub network node 12a, b according to an embodiment. The hub network node 12a, b of FIG. 2c comprises pooled baseband resources 25a. The pooled baseband resources 25a comprise multiple baseband chains 25b. In some implementations baseband resources can be moved between baseband chains whereas in other implementations this is not possible. The baseband chain 25b implements the functionality prior to mixing the baseband signal to radio frequency (or intermediate frequency). The baseband chain 25b for example performs digital signal processing, digital-to-analogue conversion, and filtering.

Each baseband chain 25b is operatively connected to a radio chain 25c. Each radio chain 25c comprises a modulator arranged to mix the output signal from the baseband chains 25b to radio frequency, filter it, and amplify it.

The output signals from the radio chains 25c are provided to a switch network 12d. The switch network 12d is arranged to switch the output signal of the power amplifier at the radio chains 25c to the correct beam forming network, thus generating the desired beams.

A radio frequency beam forming network 25e is arranged to generate the beams. In the radio frequency beam forming network 25e an incoming signal may be split into multiple signals and an individual phase shift (and potentially an amplitude tapering) may be applied to each signal prior feeding it into the individual antenna elements. In case of a fixed grid of beams 24 a set of predefined phase shifts is available for each beam than can be selected to generate the desired beam.

At reference numeral 24 the resulting beam directions are shown. In this example, eight different beam directions are supported but at most four of these can be used at the same time.

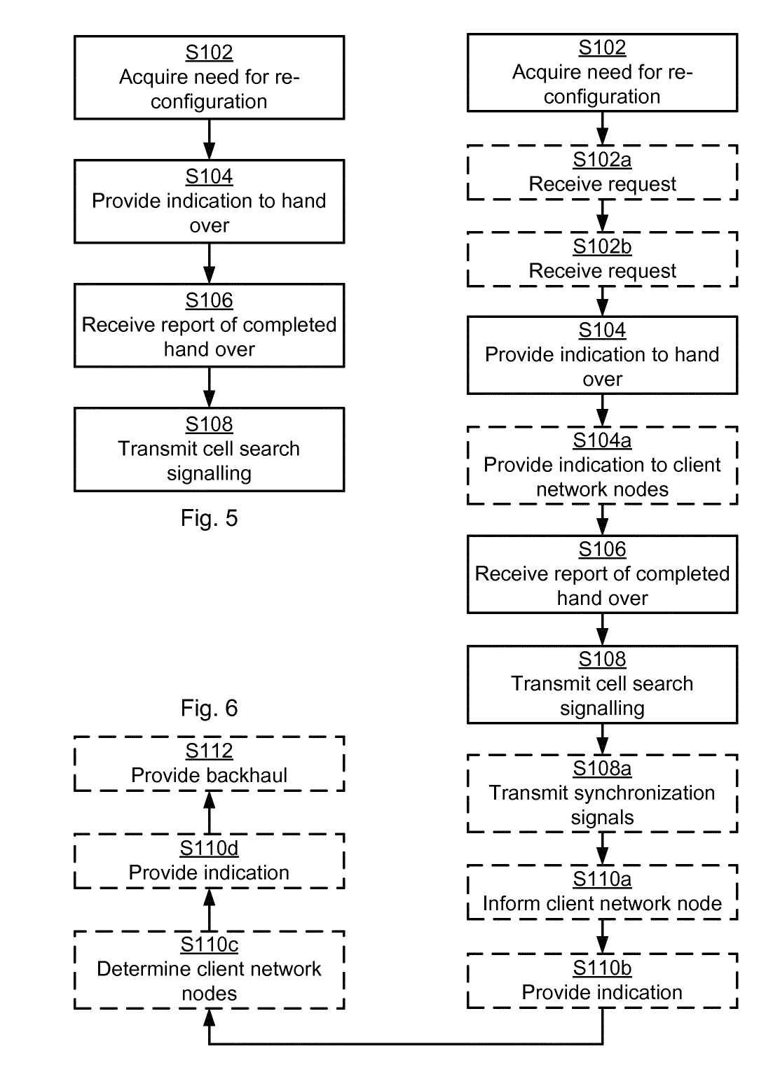

FIGS. 5, 6, and 7 are flow chart illustrating embodiments of methods for handling client network nodes backhauled by a hub network node. The methods are performed by the hub network node. The methods are advantageously provided as computer programs 32. FIG. 3 shows one example of a computer program product 31 comprising computer readable means 33. On this computer readable means 33, a computer program 32 can be stored, which computer program 32 can cause the processing unit 21 and thereto operatively coupled entities and devices, such as the communications interface 22 and the storage medium 23 to execute methods according to embodiments described herein. The computer program 32 and/or computer program product 31 may thus provide means for performing any steps as herein disclosed.

In the example of FIG. 3, the computer program product 31 is illustrated as an optical disc, such as a CD (compact disc) or a DVD (digital versatile disc) or a Blu-Ray disc. The computer program product 31 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory. Thus, while the computer program 32 is here schematically shown as a track on the depicted optical disk, the computer program 32 can be stored in any way which is suitable for the computer program product 31.

Reference is now made to FIG. 6 illustrating a method for handling client network nodes backhauled by a hub network node according to an embodiment. The method is performed by the hub network node.

The processing unit 21 of the hub network node 12a, b is arranged to, in a step S102 acquire a need for backhaul re-configuration of a client network node being backhauled by the hub network node. Examples of such needs will be provided below.

It may be assumed that the hub network node already uses all of its backhaul radio chains to backhaul one or multiple client network nodes. Furthermore, it may be assumed that the hub network node comprises more candidate beams than radio chains. If the hub network node is now requested, or even ordered, to enable additional client network nodes to find the hub network node, e.g., causing the hub network node to sweep through some or all of its sectors and transmit synchronization and/or reference signals it cannot do that without performing some kind of modification of its backhauling since it has no radio chains free.

The processing unit 21 of the hub network node 12a, b is therefore arranged to, in a step S104 provide an indication to the client network node that a user equipment 18 served by the client network node is to be handed over.

This indication is received by the client network node. The client network node then performs handover of the user equipment 18. The client network node then reports to the hub network node that the user equipment 18 has been handed over.

This report is received by the hub network node. The processing unit 21 of the hub network node 12a, b is thus arranged to, in a step S106 receive a report that the client network node has handed over the user equipment.

The hub network node then enables client network nodes to search for the hub network node. Particularly, the processing unit 21 of the hub network node 12a, b is arranged to, in a step S108, transmit at least one of synchronization and reference signals enabling client network nodes 13a, 13b, 13c, 13d to search for the hub network node.

Hence, by indicating to a client network node to hand over its user equipment the backhaul provided by the hub network node to the client network node may be temporary interrupted. This enables the hub network node to transmit signals for, potentially new, client network nodes, so that these client network nodes may be backhauled by the hub network nodes.

The hub network node may be arranged to transmit in more radio beam directions than it has radio chains. In general terms, the hub network node is configured to transmit simultaneously in up to M out of N directions, where N>M and N is the number of beam directions, and M is the number of radio chains at the hub network node. Further, at one time instance, the hub network node may not transmit into more directions than it has radio chains.

There may be different examples of indications, as in step S104. Examples include, but are not limited to, a shutdown command or any command that only implicitly tells the client network node to handover user equipment.

The client network node may serve a plurality of user equipment. The indication may indicate that each user equipment served by the client network node is to be handed over to one of another client network node and same or another hub network node. Further, the indication may indicate that the user equipment served by the client network node is to be handed over to another client network node backhauled by another hub network node 12b.

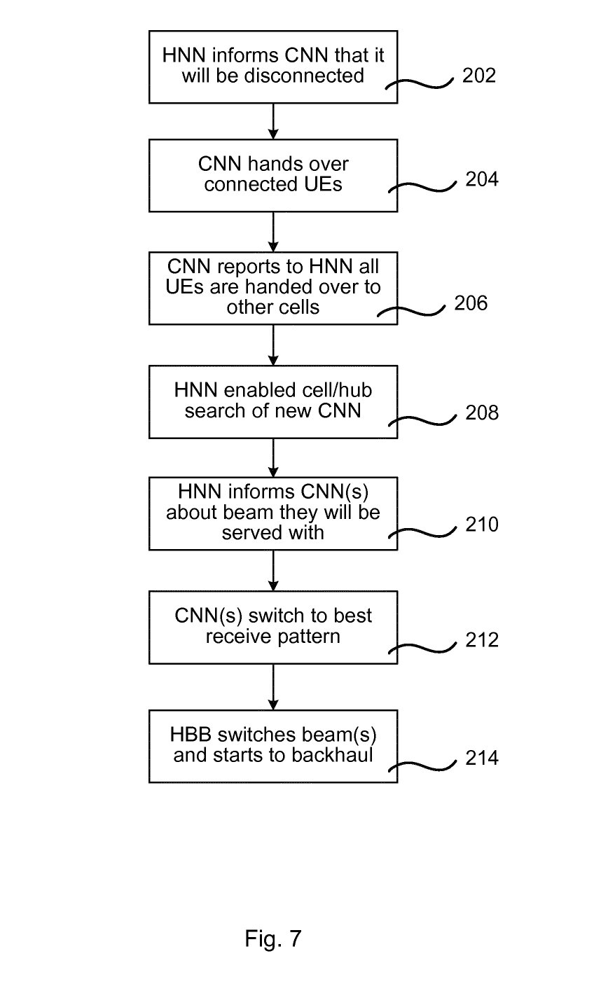

Embodiments relating to further details of handling client network nodes backhauled by a hub network node will now be disclosed. Reference is now made to FIG. 7 illustrating methods for handling client network nodes backhauled by a hub network node according to further embodiments.

There may be different ways to enable client network nodes 13a, 13b, 13c, 13d to search for the hub network node, as in step S108. Different embodiments relating thereto will now be described in turn.

For example the hub network node may transmit synchronization signals. According to an embodiment the processing unit 21 of the hub network node 12a, b is thus arranged to, in an optional step S108a transmit synchronization signals into at least one cell sector. The synchronization signals may be primary and/or secondary synchronization signals (PSS/SSS). Step 108a may be part of step S108.

For example a radio chain currently used for providing backhaul may be freed so that the radio chain may be used for transmitting at least one of synchronization and reference signals. Thus according to an embodiment a radio chain previously used for providing backhaul to the client network node is used for transmitting at least one of synchronization and reference signals, as in step S108.

For example the hub network node may informs other client network nodes than the at least one client network node being re-configured that the beam (radio chain) used for backhauling is to be shared between the client network nodes. In general terms, while the client network node that switches beam has to be informed, the client network node that is already now served by the hub network node and has to share its beam in the future has not necessarily to be informed that its beam will be shared din the future. According to an embodiment the processing unit 21 of the hub network node 12a, b is thus arranged to, in an optional step S110b, provide an indication to at least two client network nodes that a radio beam to be used for backhauling the at least two client network nodes is to be shared between the at least two client network nodes. There may be different ways to determine which client network nodes can be served by which beam (radio chain). For example, history data may be used for this purpose. Particularly, according to an embodiment the processing unit 21 of the hub network node 12a, b is arranged to, in an optional step S110c, determine which client network nodes are to share a radio beam based on history data relating to previous backhauling of the client network nodes. The history data may thus provide information about properties of communications links, such as quality of service, bit error rates, etc., previously used for backhauling the client network nodes.

There may be different ways to acquire the need for backhaul re-configuration of a client network node, as in step S102. Different embodiments relating thereto will now be described in turn.

For example, the need for re-configuration may be implicitly included in a message stating that the hub network node should enable (new) client network nodes to find it. In this respect, the term implicit is used since the hub network node has too few radio chains to backhaul yet another client network node and thus has to re-configure backhaul of one of its existing client network nodes to free a radio chain. Particularly, the client network node may be a member of a set of client network nodes. The hub network node is already using all its backhaul radio chains to provide backhaul to the set of client network nodes. According to an embodiment the processing unit 21 of the hub network node 12a, b is arranged to, in an optional step S102a, receive a request to provide backhaul to at least one further client network node 13c. Step 102a may be part of step S102. The indication may be sent to more than one client network node. Particularly, according to an embodiment the processing unit 21 of the hub network node 12a, b is arranged to, in an optional step S104a, provide the indication to at least two of the client network nodes in the set of client network nodes. Step 104a may be part of step S104.

The need for a client network node to handover user equipment to another cell can also be requested for other purposes. For example, the client network node itself may require to re-configuration (possibly after being instructed by the hub network node or some other node). Examples of such re-configuration include, but are not limited to, the client network node to search for new/better hub network nodes or beams. In such cases the client network node has to redirect its receive beam into different directions and thus the backhaul will be lost. Hence, according to an embodiment the client network node is by the hub network node backhauled by a first radio beam. To avoid interruption of served user equipment the currently served user equipment of the client network node are handed over to other cells. Once the client network node does not serve any user equipment it will start with its re-configuration procedure. According to an embodiment the processing unit 21 of the hub network node 12a, b is arranged to, in an optional step S102b, receive a request that backhaul of the client network node needs to be re-configured. The re-configuring involves the client network node to search for a new radio beam of the hub network node for backhauling the client network node. Step 102b may be part of step S102.

For example, the client network node indicated to hand over its user equipment may be allowed or disallowed to take part in the cell search procedure. The hub network node may be configured to either implicitly or explicitly inform the client network node about this. Hence, according to an embodiment the processing unit 21 of the hub network node 12a, b is arranged to, in an optional step S110a actively inform the client network node to be re-configured to one of allowing and disallowing the client network node to be re-configured to participate in the cell search.

There may be different ways to resume the backhaul of the client network node indicated to handover its user equipment. For example, one beam (radio chain) may be shared by at least two client network nodes. Hence, according to an embodiment the processing unit 21 of the hub network node 12a, b is arranged to, in an optional step S112 provide backhaul for at least two client network nodes using one shared radio beam. Abeam (radio chain) may be shared between the new client network node and client network node handing over its user equipment. Thus, according to an embodiment the one shared radio beam is shared between the client network node and a further (new) client network node.

There may be different ways to inform the client network nodes regarding which beams (radio chains) to use for backhaul. For example, the hub network node may use a free radio chain to inform (all) client network nodes of the decision. According to an embodiment the processing unit 21 of the hub network node 12a, b is arranged to, in an optional step S110d provide an indication to the client network node to be re-configured by which radio beam it is to be backhauled.

A scenario involving handling client network nodes backhauled by a hub network node and relating to at least some of the above disclosed embodiments will now be described with reference to the flowchart of FIG. 8.

Step S202: To free one of its radio chains the hub network node informs one or multiple of its backhauled client network node to handover all of the served UEs to other cells (as in step S104 above). For simplicity it is assumed a single backhauled client network node 13a is ordered so. The cells the user equipment are handed over to could be an overlaid macro cell or pico cell. The handover is a regular handover, i.e., different user equipment may be handover to different client network nodes. The client network node 13a is denoted the source client network node.

Step S204: For each of its served user equipment, the source client network node contacts a suitable (possible different) client network node (denoted target client network node) to prepare handover. Handover is then performed.

Step S206: Once the source client network node does not serve any user equipment it reports this back to the hub network node. This report is received by the hub network node (as in step S106).

Step S208: The hub network node uses now the freed radio chain to enable cell/hub search of other client network nodes, e.g., by transmitting PSS/SSS into one or multiple sectors. During this procedure a client network node that has succeeded to find to the hub network node may report a list with found beams and quality measures, e.g., Reference Signal Received Power (RSRP). The client network node 13a whose backhaul has been disconnected may participate in the search procedure. It is possible that multiple new client network nodes find the hub network node. For simplicity, and without losing generality, it is according to this exemplary scenario assumed that a single new client network node finds the hub network node.

After the search procedure is finished the hub network node prepares to backhaul the newly found client network node. The newly found client network node together with the originally served client network node(s) exceed the number of radio chains at the hub network node. Therefore the hub network node has to backhaul at least two client network nodes with the same beam (and thus radio chain).

Step S210: The hub network node determines which client network nodes are to be backhauled by which beams (radio chains). The hub network node then informs the client network nodes about this decision.

Different examples relating to how this determination is performed by the hub network node will now be disclosed in turn.

According to one example the previously disconnected client network node 13a and the newly found client network node may be served within the same beam nᵢ, i=1, . . . , 8, i.e. one radio chain. Beam nᵢ is maybe not the best beam for both client network node 13a (assume that beam n₁ would be the best) and the new client network node (assume that beam n₂ would be the best) but still provides acceptable performance for both these client network node s. Assume that the hub network node determines to use beam n₂ for their backhaul. The hub network node in step S210 thus informs the client network node 13a and the newly found client network node that it will use beam n₂ to backhaul them. The hub network node may use the best beams for the client network node 13a (beam n₁) and the newly found client network node (beam n₂) respectively, to inform them about beam n₂ which will be used in the future to backhaul them. The freed radio chain can be used in a time-division multiplexing (TDM) fashion to inform the client network node 13a and the newly found client network node via beam n₁ and n₂, respectively. Subsequently the hub network node switches the radio to beam n₂ and starts backhauling the client network node 13a and the newly found client network node.

Step S212: The client network node 13a and the newly found client network node—after having been informed about beam n₂ with which they will be backhauled in the future—switch their receive pattern to the best receive pattern for this beam (learned during the beam search procedure). User equipment can now be handed over to the client network node 13a and the newly found client network node.

According to one example the client network node 13a and the newly found client network node cannot be served by the same beam but may be grouped with other client network nodes to be served by the same beam. For example, assume that the client network node 13a is served best by beam n₄, the newly found client network node is best served by beam n₄, and that another client network node backhauled by the hub network node is best served by beam n₅. However, beam n₅ also performs sufficiently well for the newly found client network node. Therefore the hub network node in step S210 informs the client network node 13a (via beam n₁), said another client network node (via beam n₅), and the newly found client network node (via beam n₄) that they will be served via beam n₁, n₅, and n₅, respectively. The freed radio chain may be used in a TDM fashion to inform the client network node 13a and the newly found client network node about this decision; said another client network node is still regularly connected to the hub network node and may be informed in that way. Subsequently the hub network node uses one radio for beam n₁ (the client network node 13a) and one radio for beam n₅ (the newly found client network and said another client network node). The client network node 13a, the newly found client network node, and said another client network node—after having been informed about the beams with which they be backhauled in the future—switch their receive pattern to the best receive pattern for their respective beam (learned during the beam search procedure). User equipment may now be handed over to the client network node 13a and the newly found client network node.

During the cell search procedure each client network node may report a list with found beams and corresponding quality measures. According to one example the hub network node thus knows from previous search procedures that two client network nodes—which may currently be served by different beams—could sufficiently well be served by the same beam. As an example, client network nodes A, B, C, and D are served with the beams n₁,n₂,n₅, and n₇, respectively. However, it is assumed that client network node A may be sufficiently well be served via beam n₂. The hub network node informs client network node A (still via beam n₁) that it will be backhauled with beam n₂ in the future. Client network node A switches then its receive pattern to the best direction for beam n₂. Once the hub network node freed the radio chain needed previously for beam n₁ it uses this radio chain to enable cell/hub search of new client network nodes, e.g., by transmitting PSS/SSS into one or multiple sectors. Newly found client network nodes may either be served via this radio chain or client network nodes are (re-)grouped to obtain overall the best performance as described above.

Step S214: Once the scheduling of the backhauling has been determined, as in steps S210 and S212 the hub network node switches its beams accordingly and starts to backhaul the client network nodes.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-18. (canceled)

19. A method for handling client network nodes backhauled by a hub network node, the method comprising the hub network node:
acquiring a need for backhaul reconfiguration of a client network node being backhauled by the hub network node;
providing an indication to the client network node that a user equipment served by the client network node is to be handed over;
receiving a report that the client network node has handed over the user equipment; and
transmitting at least one of synchronization and reference signals enabling client network nodes to search for the hub network node.

20. The method of claim 19:
wherein the client network node is a member of a set of client network nodes;
wherein the hub network node is already using all its backhaul radio chains to provide backhaul to the set of client network nodes;
wherein acquiring a need for backhaul re-configuration comprises receiving a request to provide backhaul to at least one further client network node.

21. The method of claim 20, further comprising providing the indication to at least two of the client network nodes in the set of client network nodes.

22. The method of claim 19:
wherein the client network node is backhauled, by the hub network node, by a first radio beam;
wherein acquiring a need for backhaul reconfiguration comprises receiving a request that backhaul of the client network node needs to be reconfigured, the reconfiguring involving the client network node searching for a new radio beam of the hub network node for backhauling the client network node.

23. The method of claim 19, wherein the indication indicates that each user equipment served by the client network node is to be handed over to one of another client network node and hub network node.

24. The method of claim 23, wherein the indication indicates that the user equipment served by the one of the client network nodes is to be handed over to another client network node backhauled by another hub network node.

25. The method of claim 19, wherein the transmitting at least one of synchronization and reference signals comprises transmitting synchronization signals into at least one cell sector.

26. The method of claim 19, wherein a radio chain previously used for providing backhaul to the client network node is used for transmitting at least one of synchronization and reference signals.

27. The method of claim 19, further comprising actively informing the client network node to be reconfigured of one of allowing and disallowing the client network node to be reconfigured to participate in the search for the hub network node.

28. The method of claim 19, further comprising providing an indication to the at least two client network nodes that a radio beam to be used for backhauling the at least two client network nodes is to be shared between the at least two client network nodes.

29. The method of claim 19, further comprising determining which client network nodes are to share a radio beam based on history data relating to previous backhauling of the client network nodes.

30. The method of claim 19, further comprising providing an indication to the client network node to be reconfigured by which radio beam it is to be backhauled.

31. The method of claim 19, further comprising providing backhaul for at least two client network nodes using one shared radio beam.

32. The method of claim 31, wherein the one shared radio beam is shared between the client network node and a further client network node.

33. A hub network node for handling client network nodes backhauled by the hub network node, the hub network node comprising:
a processor;
a communications interface;
memory comprising instructions executable ty the processor whereby the hub network node is operative to:
acquire a need for backhaul reconfiguration of a client network node being backhauled by the hub network node;
provide an indication to the client network node that a user equipment served by the client network node is to be handed over;
receive a report that the client network node has handed over the user equipment; and
transmit at least one of synchronization and reference signals enabling client network nodes to search for the hub network node.

34. The hub network node of claim 33, wherein the hub network node is configured to transmit in more radio beam directions than it has radio chains.

35. A computer program product stored in a non-transitory computer readable medium for controlling a hub network node to handle client network nodes backhauled by a hub network node, the computer program product comprising software instructions which, when run on a processor of the hub network node, causes the hub network node to:
acquire a need for backhaul reconfiguration of a client network node being backhauled by the hub network node;
provide an indication to the client network node that a user equipment served by the client network node is to be handed over;
receive a report that the client network node has handed over the user equipment; and
transmit at least one of synchronization and reference signals enabling client network nodes to search for the hub network node.
